(19) United States
(12) Patent Application Publication
(10) Pub. No.: US 2006/0102703 A1
(43) Pub. Date: May 18, 2006

(54) Circuit board soldering method utilizing thermal mass compensating pallets

(76) Inventors: Salman Akhtar, Vernon Hills, IL (US); Scott A. Darrow, Quincy, IL (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/987,391

(22) Filed: Nov. 12, 2004

(51) Int. Cl. B23K 1/08

(52) U.S. Cl. 228/260; 228/44.3; 228/37

(57) ABSTRACT

A pallet for supporting a circuit board during a soldering process. The pallet has a thermal mass that is varied to offset a thermal mass of the circuit board so as to minimize the difference in temperatures across the circuit board during the soldering process. The thermal mass of the pallet is varied by build up or removal of material of the pallet in selected areas, and/or through the use of materials having varying thermal properties. In addition, the total thermal mass of the pallet and the circuit board is maintained to stay within a set range in order to allow a soldering process to accommodate more than one type of circuit board with minimal to no adjustments in the process settings between boards. Construction of the pallet is preferably performed in an iterative process wherein temperature variations in the circuit board are measured during heating cycles and the pallet is modified in response to the differences in temperature at different areas.

### BACKGROUND OF THE INVENTION

1) Field of Invention

The present invention concerns a method of improving circuit board soldering by compressing the difference of temperatures across the circuit board and between circuit board assemblies during the soldering operations.

2) Description of Related Prior Art

In the production of circuit boards, electronic components are fixed to the board by soldering. Wave soldering, also referred to as flow soldering, is often used to fix through-hole components to the circuit boards and reflow soldering is used to fix surface mounted components to the circuit boards.

A typical soldering process contains the following three stages: flux application, preheat, and soldering.

In flux application, a flux is applied to the solder surface areas of the circuit board and components. Flux is a substance that increases the surfaces fusibility, by removing oxides from the surfaces.

In the preheat stage, the circuit board and components are exposed to relatively high temperatures. This stage serves two main functions. First, by exposing the board and components to high temperatures gradually over time, thermal shock is less likely to occur when the components and board face even higher temperatures in a shorter duration during the soldering stages. Second, specific high temperatures in preheat are necessary to activate the flux. However, the flux will decompose or burn up rather than activate if the temperatures are too high. Therefore it is important to ensure that the temperatures reached on the board and components during preheat are high enough to activate the flux but not so high as to burn up the flux. This range is referred to as the flux activation temperature range.

But, due to the various components and the shape of the board, different areas of the board heat up at different rates creating a difference of temperatures across the board. This difference of temperatures across the board creates a problem for staying within the flux activation temperature range across the board during the soldering process. Specifically, one area of the board might be within the flux activation temperature range while another area of the board is not because of the difference in temperature from one area to another. It is desirable to have the differences in temperatures to be as small as reasonably achievable and within the flux activation temperature range as the circuit board passes through the soldering process.

In wave soldering, for example, in the soldering stage, the board and components are exposed to a fountain of molten solder which applies solder to the component leads and board forming a bond between the two. In reflow soldering, the board and components are exposed to temperatures high enough to melt the solder paste around the component leads and the board forming a bond between the two when the solder cools and solidifies. These soldering stages may not be effective if the flux was not properly activated. Therefore an unacceptable wide difference of temperatures across the board can be a detriment to the overall yield and throughput of a soldering process.

The conventional method for ameliorating the difference in temperatures on the board is by reducing the speed at which the board travels through the preheat stage and lowering the temperatures during the preheat stage. This is because components with differing thermal mass (and therefore differing rate of heating) will produce a narrower variation in temperatures if the rate of heating is slowed. Typically the preheat stage will be broken into a series of zones where each zone will expose the board to a higher temperature. The slower travel speed and exposure to a more gradual increase in temperature allows for the board to heat up slower and reduce the difference in temperatures across the board.

However, slowing down the travel speed has two negative consequences. Slower speeds reduce the yield of the soldering process by reducing the number of boards that can go through the process during a given time. Also, the board's travel speed in the preheat stage is necessarily the same travel speed for the board in the soldering stage as the stages are typically in line. Therefore a slower travel speed in the preheat stage results in a slower travel speed in the soldering stage. Because the board is traveling slower in the soldering stage, the board will be in contact with the molten wave of solder longer. The amount of time the board is in contact with the wave of solder is referred to as the “dwell time.” A long dwell time has a negative impact on the soldering process yield.

Furthermore, the use of a series of zones with specified times and durations, referred to as a profile, interferes with a soldering process which processes more than one board set-up. A board set-up is a board with a specified shape and pattern of components attached thereon. For example, one board set-up may have more components than in another set-up or one set-up may have the same components but different placement on the board. Not only may the components vary between boards but also the board's shape or construction may vary from board to board. The variation between one board set-up to another requires a different profile for each board set-up in the soldering process. This is because each board set-up has a different total thermal mass. A board set-up with a higher total thermal mass will heat up slower than a board set-up with a lower thermal mass.

In order to use the appropriate profile for the correct board set-up, manufacturers run the boards through the process in batches. Each batch is a group of boards with the same set-up and thus uses the same profile. However using batches reduces the flexibility of the soldering process and requires undesirable downtime between the batches in order to change from one profile to the next.

Therefore, it would be advantageous to have an apparatus and a process for enabling selective temperature control of different areas of a circuit board during preheating and other soldering processes. In addition, it would be advantageous if the process and apparatus produced an increase in the travel speed for the boards during the process.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a schematic of one embodiment of a pallet of the present invention supporting a circuit board;

FIG. 2a shows a cross sectional view of the pallet of FIG. 1;

FIG. 2b shows a cross section view of the pallet in another embodiment used in reflow soldering without soldering openings;

FIG. 3 shows a close up view of an extended area of a circuit board and a U-shape material block.

FIG. 4 shows a schematic of another embodiment of a pallet of the present invention; and

FIG. 5 is a flowchart illustrating a method for constructing a pallet of the present invention with a varying thermal mass configured to offset the varying thermal mass of a circuit board.

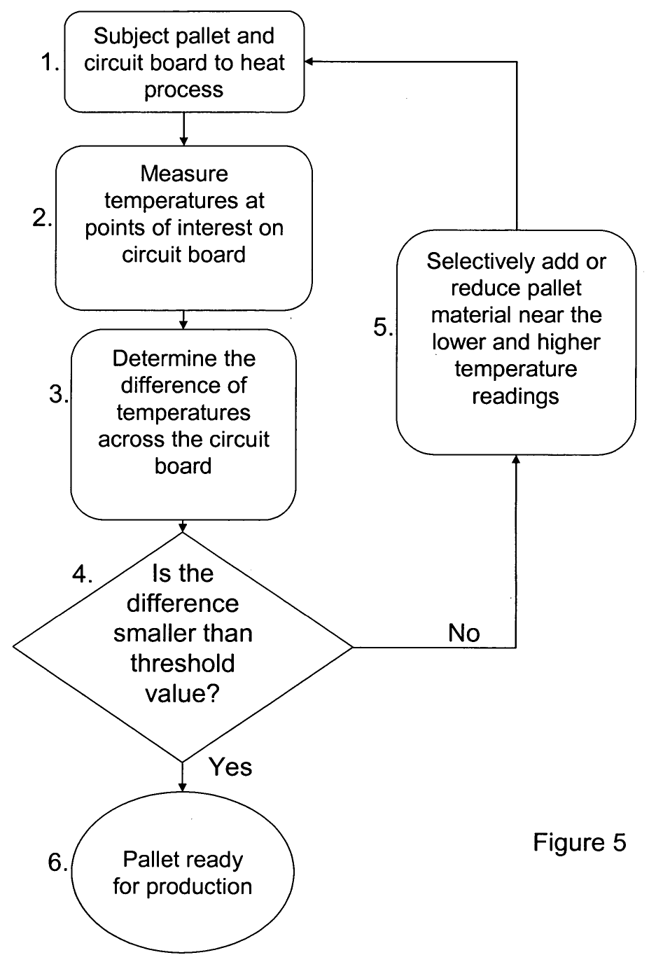

### BRIEF DESCRIPTION OF EXEMPLARY EMBODIMENTS

The present invention addresses the above needs and achieves other advantages by providing a special pallet for supporting a circuit board during a soldering process. The pallet has a thermal mass that is patterned to offset the thermal mass of the circuit board so as to minimize any difference in temperatures across the board during the soldering process. The thermal mass of the pallet is varied by build up or removal in selected areas of thermal mass, which for example may be material of the pallet and/or through the use of materials having varying thermal properties. In addition, the total thermal mass of the pallet and the circuit board is maintained to stay within a set range in order to allow a soldering process to accommodate more than one type of circuit board with minimal to no adjustments between boards Construction of the pallet is preferably performed in an iterative process wherein the difference in temperatures across the circuit board are measured during heating cycles and the pallet is modified in response to the variations in temperature at different areas.

In one embodiment, the present invention includes a pallet for supporting a circuit board during a soldering or heating process. The circuit board has a varying thermal mass due to its shape and the variety of electrical components supported thereon. Included in the varying thermal mass are areas of higher thermal mass and areas of lower thermal mass. The pallet includes a body with at least one support surface configured to engage the circuit board and at least one area of selective variation in thermal mass configured to offset the varying thermal mass of the circuit board.

Offsetting or compensating the thermal mass of the board with the pallet's thermal mass can be accomplished in several ways. For example, the thermal mass of one area of the pallet can be increased with a build up of material that is configured to be in proximity to an area of the circuit board that has a lower thermal mass. Conversely, the thermal mass of one area of the pallet can be reduced by a cut out of material that is configured to be in proximity to an area of the circuit board that has a higher thermal mass.

Another example of varying the thermal mass of the pallet in order to offset the thermal mass of the board is in material selection and variation. Instead of increasing or decreasing the amount of pallet material, a different material may be used in selected areas. In particular, in order to offset an area of the board with a lower thermal mass, the pallet could be configured to have an insert replacement with material that contains a higher thermal resistance than the original material. Conversely, in order to offset an area of the board with a higher thermal mass, the pallet could be configured to have an insert replacement with material that contains a lower thermal resistance than the original material.

Achieving a total thermal mass within a set range when the pallet and board are combined is another aspect of the invention. By configuring the total thermal mass of the pallet to achieve a certain range of total thermal mass when combined with the pallet, one soldering process will be able to accommodate an assortment of different types of boards with minimal to no adjustments in the process settings between boards.

In another aspect of the invention, the pallet and the circuit board together have a general consistent resistance to heating when combined. Therefore during a heating process, the circuit board will have a smaller difference in temperatures across its surfaces.

In another embodiment, the present invention includes a method of constructing a pallet. The pallet construction method includes supporting a circuit board on a pallet and subjecting the circuit board and pallet to a heat source. During the heating process, the temperature is measured in a least two points on the board and compared. If the difference between the temperatures is greater than a threshold value then the thermal mass on the pallet is modified. For example, the thermal mass may be increased in areas of the pallet near the lower temperatures points on the board. Alternatively, the thermal mass may be decreased in areas of the pallet near the higher temperature points on the board.

In another aspect, the present invention concerns a method of improved soldering of a circuit board populated with components having differing thermal mass or thermal sensitivity. The method involves providing a circuit board pallet to mate with the circuit board during an oven soldering operation. The pallet is configured such that it has areas of different thermal mass associated with different component locations on a mated circuit board.

According to another aspect of the invention, a method is provided which improves the throughput of a circuit board soldering operation in which circuit board assemblies of varying thermal mass are intermixed on the soldering line. The method involves mating with at least selected ones of the circuit board assemblies having a lower thermal mass than others a pallet whose thermal mass is chosen to augment the thermal mass of the mated circuit board assemblies. The result is to compress the range of thermal masses of the circuit board assemblies soldered and thereby enable an increased process throughput. As will be described below, the principles of the invention are applicable in a variety of types of circuit board soldering, including wave, reflow, and others.

The present invention has several advantages. In reducing the difference in temperatures across the circuit board during the heating process, the invention controls one of the more volatile process variables in a soldering process, and thus reduces solder defects. The pallet of the present invention reduces the difference in temperatures across the board without the need to slow down the travel speed of the board during the process, and thus increases output. In setting a total thermal mass for the pallet and circuit board, a soldering process can accommodate several types of boards with minimal to no adjustments in the process settings between boards. The pallet reduces the need for changes in machine settings between one circuit board set-up to another, and thus reduces the traditional down-time associated with changing from one circuit board set-up to another. Also the reduce difference in temperatures insulates the process to other variables such as seasonal changes.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

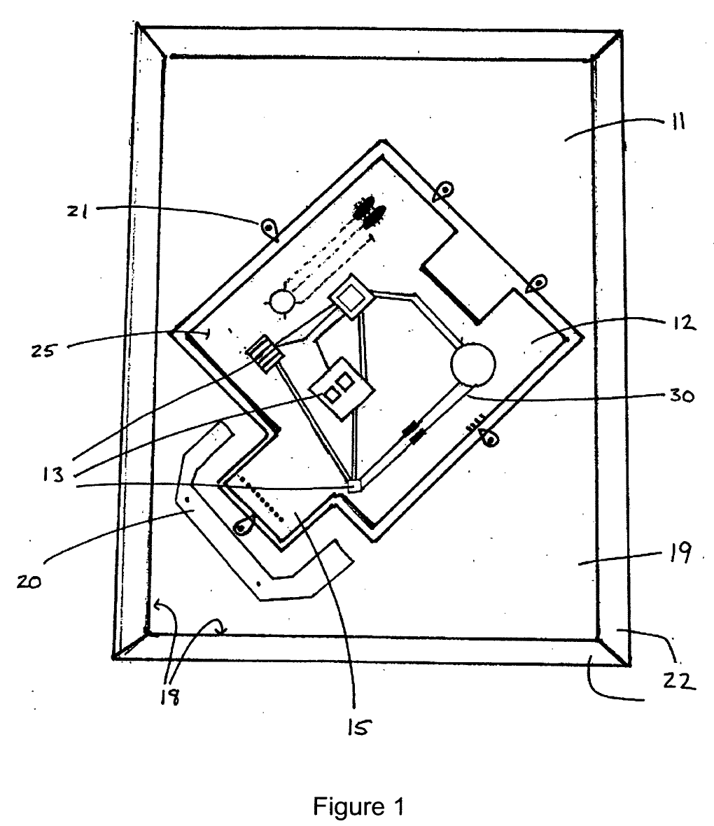

In general, as shown in FIG. 1, the present invention in the illustrated embodiment includes a pallet assembly 10 having a pallet 11 for supporting a circuit board 12 during the preheat stage of a wave soldering process. Advantageously, the pallet assembly 10 as a whole has a generally consistent thermal mass so as to minimize the difference in temperatures across the assembly during the preheat stage of a wave soldering process.

Although the pallet assembly 10 is primarily described herein as being employed in the preheat stage of a wave soldering process, the pallet assembly may also be used with other heating processes. For example, the pallet may be used in a reflow soldering process or hot forming process.

Further, although the illustrated embodiments are shown with the pallet 11 supporting a circuit board 12, the pallet 11 of the present invention may be employed with other temperature sensitive work pieces. For example, the pallet may used in the processing of selective fit parts, such as shims or tappets.

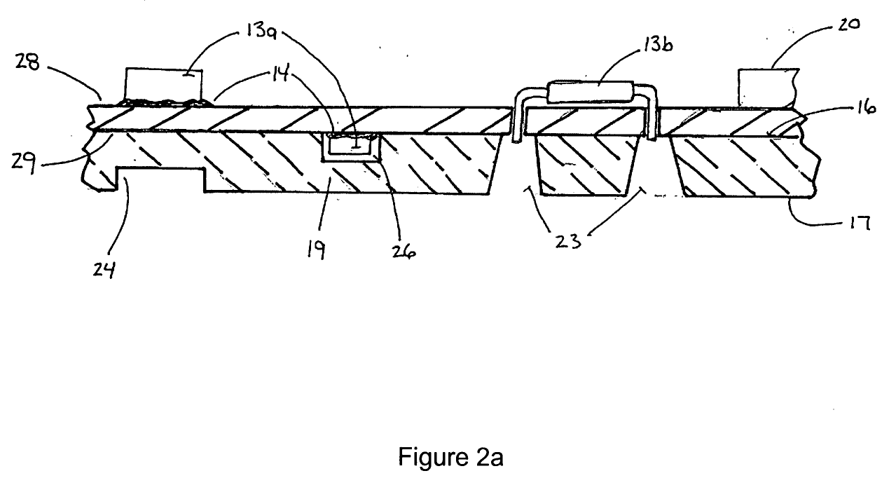

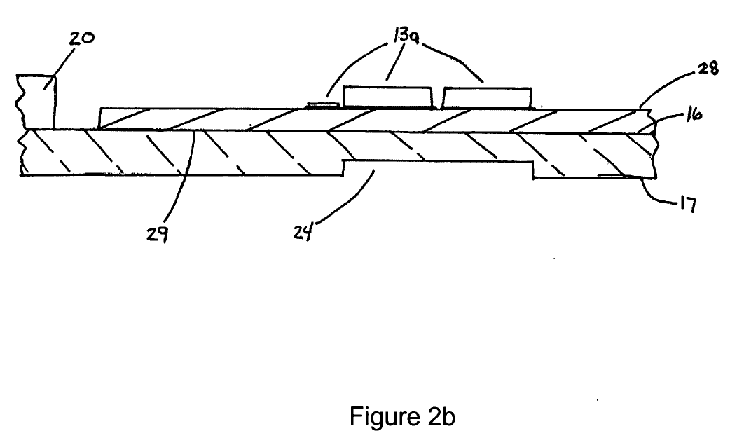

The circuit board 12, as shown in FIGS. 1 and 2, includes a panel 25, electronic components 13, and solder joints 14. The panel 25 has a top side 28, bottom side 29, and an etched circuit pattern 30 embedded within the panel. The electronic components 13 are typically either surface-mounted components 13a or through-hole components 13b. Surface mounted components 13a are fixed to the panel 25 via the solder joint 14 formed between the component 13a and the panel 25 usually by a reflow soldering process. The solder joint 14 provides both the mechanical bond between the panel 25 and the component 13a and the electrical connection between the component 13a and one of the etched circuit patterns 30 in the panel. With the through-hole component 13b, the component 13b is mechanically supported by the insertion of the leads of the component through a through-hole defined by the panel 25 from the panel top side 28 to the panel bottom side 29. The leads of the through-hole component 13b extend past or line up to the panel bottom side 29. The leads will be soldered to the panel bottom side 29 during a wave soldering station forming an electrical connection.

Circuit boards typically have a collection of generally rectangular shapes, as with the circuit board 12 illustrated in FIG. 1. However, it should be noted that the pallet assembly 10 and method of the present invention is not limited to any particular circuit board configuration, and instead may be employed with circuit boards that come in a variety of shapes and sizes. For example the circuit board 12 may be circular in shape, or may be non-planar, or may have a collection of curved, straight, or irregular shapes. Furthermore the circuit boards may also have one or more extended areas, such as the rectangular extended area 15 of the circuit board 12 shown in FIG. 1. Any extended areas may add to the circuit board 12 having an irregular shape. Moreover, the more irregular the circuit board shape, the more likely areas of the board will have significant difference in temperatures from one area of the board to the next during any heating process, and the more likely it is to benefit from the present invention.

Similarly, the electronic components 13 on the circuit boards 12 may come in a variety of shapes, sizes, and material depending on the component 13. Some examples of components 13 on a circuit board 12 are semiconductors, batteries, resistors, capacitors, inductors, transformers, diodes, fuses, jumpers, heat sinks, and counters. Also, the placement of these components 13 and the use of all or any of these components 13 on a circuit board 12 vary greatly depending on the application of the circuit board 12.

Because of variations in the placement of the components 13 and the shape, size, and material properties of the components 13, and the shape of the circuit board 12, the thermal mass across the circuit board 12 varies. Areas of higher thermal mass create a higher resistance to heating, while areas of the circuit board 12 with a lower thermal mass create a lower resistance to heating. Therefore, when the circuit board 12 and components 13 are exposed to a heat source, such as an oven during preheat of a wave soldering process, different areas of the circuit board 12 heat at different rates giving the circuit board 12 a difference in temperatures across the board. For example, areas of the circuit board 12 that have a higher concentration of components 13 will heat slower due to a higher thermal mass than an area of the circuit board 12 that has fewer components 13. Another example, an extended notch area 15 on the circuit board 12 would heat relatively faster than most other areas of the circuit board 12 due to having more of the circuit board 12 area exposed to the heated air or environment.

As shown in FIG. 1-2, the pallet 11 includes a pallet body 19, a plurality of rotary hold downs 21, and edge stiffeners 22. The pallet body 19 further includes one or more support surfaces 16, a solder surface 17, side edges 18 and attached material blocks 20. Also, defined by the pallet body 19 are a plurality of solder openings 23 and material recesses 24.

As illustrated in FIG. 1, the pallet 11 is rectangular in shape. However the pallet 11 of the present invention is not limited to the illustrated rectangular shape, but may be varied extensively depending, among other things, upon the general shape of the circuit board, the number of circuit boards the pallet will support, and the space limitations in the preheat oven or other manufacturing station.

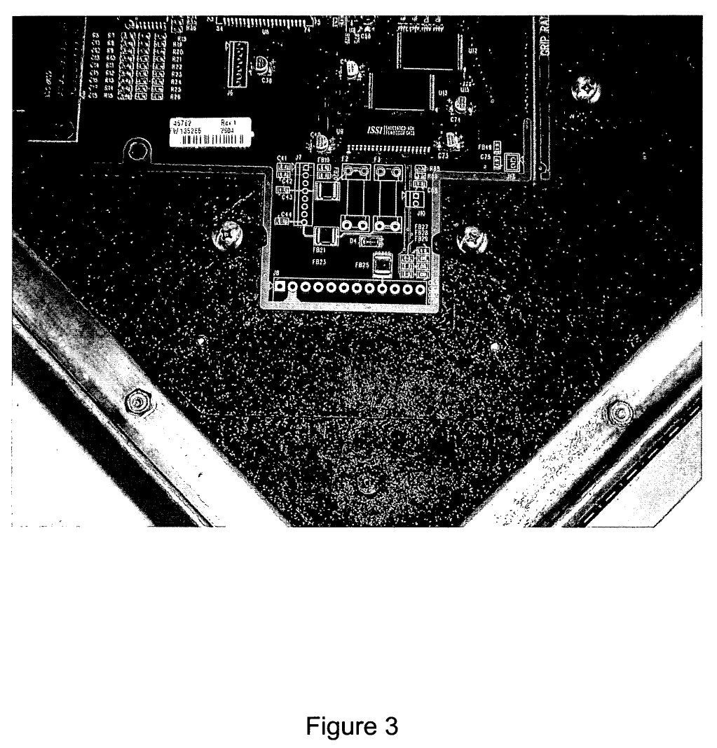

At least part of the circuit board 12 engages the support surface 16 of the pallet body 19 during the heating operation so that support is provided for the circuit board 12. The circuit board 12 is held in place against the support surface 16 with the rotary hold downs 21 which are fastened to the support surface 16 and located around the outer perimeter of the circuit board 12, as shown in FIG. 3.

The rotary hold downs 21 include a screw 31 and a flange 33 with an opening. The screw 31 and flange 33 are made with materials that can withstand soldering conditions. For example the screws may be made from stainless steel and the flange may be static dissipative, high temperature plastic. Other types of fasteners, latches and similar mechanisms can be used to hold the circuit board 12 against the support surface 16 and still be within the scope of the present invention.

Also, the rotary, or other, types of hold downs 21 may not be necessary. For example, the circuit board 12 may be heavy enough to prevent the circuit board 12 from lifting away from the pallet 11 during the wave soldering station. Ridges or bumpers located around the outer perimeter of the circuit board 12 on the body support surface 16 may be used to prevent the circuit board 12 from moving along the body support surface 16. It should be noted that any fasteners or ridges added to the pallet 11 to secure the circuit board will modify the thermal mass because of the additional mass and thermoproperties of the fasteners or ridges. Therefore, the present invention may incorporate selection of different types of hold downs, ridges, bumpers, etc. to offset the thermal mass of the circuit board 12.

As shown in FIG. 2a, the pallet body 19 defines solder openings 23 which are through-holes from the solder surface 17 to support surface 16. The solder openings 23 allow for solder to reach the targeted areas on the circuit board 12 during the wave soldering process. The target areas are the areas where the leads of the through-hole components 13b are extending out or lined up with the panel bottom side 29. During the wave soldering station, the pallet assembly 10 will pass over a fountain of molten solder where the molten solder will engage the solder surface 17. Due to the resistance of the pallet material to solder, the molten solder will splash primarily against the solder surface 17. However, the solder openings allow the molten solder to engage the panel bottom side 29 and the leads of the through-hole component 13b directly in order to form a solder joint.

The number and placement of the soldering openings 23 vary according to the number and placement of the through-hole components 13. The size of the soldering openings 23 is dependent on the size of the component lead that is to be soldered. Typically, the soldering openings 23 are not larger than the size necessary to solder the component lead to the panel bottom side 29 so as to prevent thermal shock, or other defects, due to exposure of the panel 25 or other components 13 to the very high temperature of the molten solder.

As shown in FIG. 2b, in another embodiment of the invention, the pallet 11 may have no soldering openings 23. For example, the pallet may support a circuit board 12 through a reflow soldering process where soldering openings 23 are not necessary.

The material recesses 24 are protrusions into the pallet body 19 from either the support surface 16 or solder surface 15. The material recesses 24 reduce the thermal mass of the pallet body 19 in that area by reducing the amount of body material. Typically, the material recesses 24 are located underneath or adjacent to areas of the circuit board 12 with relatively higher thermal mass so as to offset that thermal mass.

Material recesses 24 may form a variety of shapes. For example, the recesses may define a rectangular shape or a triangular shape in the original composition of the pallet. The defined shape may also be some irregular shape. Generally then, a material recess 22 is a reduction of material in the original composition of the pallet, or formation of a negative space, intended to decrease the overall mass in an area thereby decreasing the thermal mass in that area. The material recesses 24 may be made by using manufacturing techniques for removing material, such as by reaming or milling, or may be cast or molded into the original as a negative space.

As an alternative to removing material or forming recesses, material blocks 20 may be used to increase the thermal mass of the body 19 in that area by adding or building up body material. Preferably, the material blocks 20 are located underneath or adjacent to areas of the circuit board 22 with relatively lower thermal mass so as to offset the lower thermal mass.

The material blocks 20 may be formed in the same manner as the pallet body 19. For example, the material blocks 20 may be a buildup of material that is cast or molded integrally with the rest of the pallet body. Alternatively, the material blocks 20 may be separate buildups attached to the pallet body 19 by fasteners, adhesives or other attachment methods or devices that can withstand the soldering conditions and have sufficient strength to maintain thermal communication or contact of the material blocks with the rest of the pallet body.

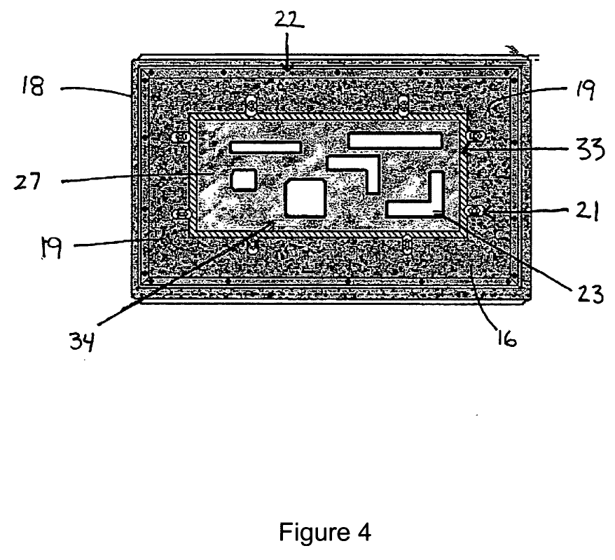

It should also be understood, as illustrated by the U-shape material block 20 in FIG. 4, the material block may come in a variety of shapes, such as varying planar, rounded, textured or irregular shapes. Therefore, as defined herein, the material block 20 can be an addition of material in any shape beyond the original composition of the pallet, or can be a build up of material in a shape formed with the rest of the pallet body, that increases the thermal mass in an area to offset a low thermal mass of the circuit board 12.

Advantageously, the material recesses 24 and the material blocks 20 of the present invention offset the thermal mass of the circuit board 12 by adding or reducing mass in the body 22. For example, as shown in FIG. 1, the extended rectangular area 15 of the circuit board 12 would heat faster compare to the rest of the circuit board 12 because of that area has a higher surface to volume ratio than the rest of the circuit board 12. In order to reduce the heat rate and thus the temperature of the extended notch area 15, a U-shape material block 20 is positioned around the extended notch area 15 and fastened to the solder surface 16. The combination of the added mass from nearby U-shape material block 20 and the extended notch area 15 increases the thermal mass in that overall area to approximate the averaged thermal mass found in the other areas of the circuit board 12. The consistency of the thermal mass reduces the difference of temperatures normally found across the circuit board 12 during heating operations.

The body 19 and the material blocks 20 can be comprised of any heat and solder resistant material capable of retaining its properties during soldering conditions. For example, materials that can be used are sold under the following trade names: DURAPOL, DELMAT, and DUROSTONE. Also, the body 19 may be comprised of different materials and mixtures of materials. For example, the body 19 may also include an interchangeable inner insert or pocket comprised of the same or different materials as the rest of the body. Likewise, the body 19 and material blocks 20 can be of different material. In fact, in some embodiments, instead of increasing or decreasing material to the body 19, a different material may be used with either a higher or lower thermal resistance in order to alter the thermal mass of the body 19.

As shown in FIG. 2a, the body 19 may also have component recesses 26. Component recesses 26 allow for the circuit board 12 to rest flatly on the support surface 16, even with components 13 attached to the bottom side 29 of the circuit board 12. Each surface mounted component 13a located on the panel bottom side 29 will be inserted into a component recess 26 when the circuit board 12 is supported by the pallet 11. Therefore, unlike material recesses 24, placement component recesses 26 is based on the surface mounted components 13a located on the panel bottom side 29. Furthermore, the shape of the component recesses 26 is determined by the shape of the corresponding surface mounted components 13a that the component recesses 26 will surround.

As shown in FIG. 4, in another embodiment, the pallet 11 may further include a board pocket 27. Generally, the board pocket 27 is an insert that fits in a large opening defined by the pallet body 19. The board pocket 27 includes circuit board support surfaces 34 and edges 33 extending around the support surfaces. In this embodiment, the circuit board 12 may engage the board pocket 27 instead of or along with the pallet body 19 for support. Also with the use of the board pocket 27, the solder openings 23, material recesses 24, and/or component recesses 26 may be defined in the board pocket instead of, or along with, the pallet body 19. Similarly, material blocks 20 may be attached directly to the board pocket 27 or on the board pocket 27 and the pallet body 19 in combination.

In another aspect of the invention, the pallet 11 may also have a total thermal mass that when combined with the total thermal mass of the board 12 is within a set range. The combined thermal mass of the pallet 11 and board 12 is also the thermal mass of the pallet assembly 10. It is advantageous to set a total thermal mass for a pallet assembly 10 because it allows for one soldering process to accommodate several different types of pallet assemblies 10 with minimal to no adjustments in the process settings between types of pallet assemblies 10. For example separate profiles, or oven settings, will not be required for each type of pallet assembly 10. This is because two different pallet assemblies 10, even with different board 12 and pallet 11 configurations, will generally have the same average temperature when exposed to the same heating conditions if the pallet assemblies 10 have generally the same total thermal mass.

Setting the total thermal mass of the pallet assembly 10 can be accomplished in several ways. The thermal mass may be approximated as weight. This is because the pallet assemblies 10 usually share the same pallet material which makes up the majority of the pallet assemblies 10 and it is the relative thermal mass between the assemblies 10 that creates the variability in average temperatures between assemblies 10. Therefore a set range in thermal mass may be considered as a set range in weight. If the set range was, for example, 4.5 to 5.5 pounds, then the pallet assembly 10 should weigh 4.5 to 5.5 pounds including with any material blocks 20 or material recesses 24. In order to achieve the 4.5 and 5.5 pounds, material blocks 20 or material recesses 24 may be added. However, any material blocks 20 or material recesses 24 would have to be place on the pallet 11 in a way not to add to the difference in temperatures across the board 12 as discussed above.

Setting the total thermal mass of the pallet assembly 10 to a set range is advantageous because it facilitates a common average temperature between different types of pallet assemblies 10 under the same preheat conditions. Setting the pallet 11 to have varying localized thermal masses to offset the localized thermal masses on the board 12 reduces any deviation from the common average. A common average temperature between pallet assemblies with less deviation from that average across the boards 12 allows the flux activation temperature range to be reach across every board 12 on every pallet assembly 10 more easily.

A method of making the pallet 11 is illustrated in FIG. 3. A starting pallet and the circuit board 12 with components 13 are subjected to a heat process, as shown by block 1. Notably, the starting pallet need not be a flat planar pallet, but could include various preformed shapes. For example the starting pallet may be circular in shape with various predefined material blocks and recesses.

During the heat process, the temperatures at the points of interest on the circuit board 12 are measured. The temperatures are compared to determine the difference of temperatures across the circuit board 12. If the difference is higher than a threshold temperature range or value then selectively add material blocks 20 to the body 19 near the lower temperature readings and/or selectively add material recesses 24 to the body 19 near the higher temperature readings.

A material recess 24 or a material block 20 is most often placed as close to the temperature reading as possible. For example, as shown in FIGS. 1 and 3, the U-shape material block 20, is located adjacent and around the extended rectangular area 15, an area that would have a higher temperature point. The U-shape material block 20 is close to the extended area 15, but still far enough away to avoid interfering with the placement or removal of the circuit board 12 and the use of the of the rotary hold downs 21.

Alternatively, a material block 20 may have been attached directly underneath the extended rectangular area 15 to the solder surface 17. However the material block 20 will typically have to be shaped and placed so as to not interfere with the soldering openings 23. The material recesses 24, on the other hand, may be more easily located directly under the temperature point in the pallet body 19, especially for a colder temperature point located away from the sides of the circuit board 12.

Regardless, once the modification are made to the pallet 11, then the pallet 11 and circuit board 12 may be again subjected to the heating process, with the temperature points being measured again to confirm that the difference of temperatures is smaller than the threshold temperature range. If the difference is not smaller than the threshold temperature range, the above-described process can be reiterated as desired until the threshold is reached.

Use of the threshold temperature range helps to ensure against areas of the circuit board 12 moving outside the flux activation temperature range and causing defects in the circuit board. For this purpose, the threshold temperature range is typically set to be the same as the flux activation temperature range. For example, in one embodiment the flux activation temperature range may be from 210° Fahrenheit to 220° Fahrenheit. Therefore in order to ensure the entire circuit board 12 is within the flux activation temperature range the difference of temperatures across the circuit board 12 must be ten degrees or less.

In the above example, the maximum threshold temperature range would be 10° Fahrenheit. However, it could be advantageous to set the threshold temperature range even lower to ensure some allowance for error. Generally, a smaller threshold temperature range results in a smaller difference of temperatures across the circuit board which insulates the heating process to other process variations.

As another option, the process may only include removal of material to form material recesses by setting a minimal weight requirement for the starting pallet. For example, setting a requirement that the unaltered pallet weigh between 4.5 to 5.5 pounds could provide the pallet 11 with enough material so that any modification to the pallet 11 would only require defining material recesses 24, i.e., removing material and not the adding of material blocks.

In another option, the process may include setting a total thermal mass range for the pallet 11 and board 12 (or pallet assembly 10). The total thermal mass may be approximated by total weight. In that example, the process would further include steps for weighing the pallet assembly 10, comparing the weight to the set range, and making adjustments accordingly. For example, additional material blocks 20 or material recesses 24 may be added in areas on the board in a manner which would not have an adverse affect to the difference of temperatures across the board 12.

The circuit board temperatures may be measured using a range of conventional sensors, such as type K thermocouples, infrared cameras, or laser temperature measuring devices. Generally, the measurements should be taken at points of interest. For example, in a wave soldering process the points of interest are the soldering locations. These soldering locations include the through-holes for insertion of the components 13.

Further, although the inventive method is illustrated with an iterative method, a non-iterative method may be used as well. For example, the pallet design may be determined based on computer models that may predict the difference of temperatures across the board without the need to measure temperature points beforehand.

The pallet 11 of the present invention has several advantages. In reducing the difference of temperatures across the circuit board 12 during the heating process, the pallet 11 controls one of the more volatile process variables in a soldering process and thus reduces solder defects. The pallet reduces the difference of temperatures across the board 12 without the need to slow down the travel speed of the board 12 during the process, and thus increases output. In setting a total thermal mass for the pallet 11 and circuit board 12, a soldering process can accommodate several types of boards with minimal to no adjustments to the process settings between boards. The pallet 11 reduces the need for changes in machine settings between one circuit board set-up to another, and thus reduces the traditional down-time associated with changing from one circuit board set-up to another. Also the reduce difference of temperatures insulates the process to other variables such as seasonal changes in the environment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A pallet for supporting a circuit board during a soldering process, said circuit board having a varying thermal mass with at least one area of higher thermal mass and at least one area of lower thermal mass, said pallet comprising:
at least one support surface configured to engage at least one surface of the circuit board; and
a body including the at least one support surface, said body also including at least one area of selective variation in thermal mass configured to offset the varying thermal mass of the circuit board.

2. A pallet of claim 1, wherein the selective variation includes an area of the body having a higher thermal mass to heating that is configured to be positioned in proximity to the area of the circuit board having the lower thermal mass.

3. A pallet of claim 2, wherein the selective variation includes an area of the body having a lower thermal mass that is configured to be positioned in proximity to the area of the circuit board having the higher thermal mass.

4. A pallet of claim 3, wherein the area of the body having the higher thermal mass includes an area of greater material volume and wherein the area of the body having the lower thermal mass includes an area of lesser material volume.

5. A pallet of claim 4, wherein the greater material volume includes a buildup of a material of the body and wherein the lesser material volume is defined by at least partial removal of the material of the body.

6. A pallet of claim 3, wherein the area of the body having the higher thermal mass includes a material with a greater thermal resistance and wherein the area of the body having the lower thermal mass includes a material with a lower thermal resistance.

7. A pallet of claim 1, wherein the total thermal mass of the board and circuit board is within a set range.

8. A pallet of claim 1, wherein the total weight of the board and the circuit board is within a set range.

9. A pallet of claim 8, wherein the set range is 4.5 to 5.5 pounds.

10. A pallet for supporting a circuit board during a soldering process, said circuit board having at least one area of lower thermal mass than an average thermal mass of the entire circuit board, said pallet comprising:
at least one support surface configured to engage at least one surface of the circuit board; and
a body including the at least one support surface and having an area of higher thermal mass positioned in proximity to the at least one area of the circuit board having a lower thermal mass;
wherein the pallet and the circuit board have a complimentary thermal mass when combined so as to reduce the difference of temperatures across the circuit board during the soldering process.

11. A pallet of claim 10, wherein the complimentary thermal mass when combined also equals a set range.

12. A pallet of claim 10, wherein the total weight of the pallet and the circuit board is within a set range.

13. A pallet of claim 12, wherein the set range is 4.5 to 5.5 pounds.

14. A pallet of claim 10, wherein the difference of temperatures is less than ±10° Fahrenheit.

15. A pallet of claim 10, wherein the difference of temperatures is less than ±5° Fahrenheit.

16. A pallet of claim 10, wherein the difference of temperatures is less than ±1° Fahrenheit.

17. A method of making a pallet for supporting a circuit board, said method comprising:
supporting the circuit board with the pallet;
subjecting the circuit board to a source of heat;
determining a difference in temperature between at least two points of the board;
comparing the difference in temperature to a threshold temperature difference;
selectively changing an amount of thermal mass in one of the areas of the pallet in order to reduce the difference in temperature measured on the board.

18. A method of claim 17, further comprising repeatedly comparing the difference in temperature and selectively changing the amount of thermal mass until the threshold temperature is met.

19. A method of claim 18, further comprising measuring the total weight of the pallet and circuit board against a threshold weight range and selectively changing an amount of weight of the board if necessary to achieve said threshold weight range.

20. A method of claim 19, wherein the threshold weight is 4.5 to 5.5 pounds.

21. A support platform for conveying a work piece through a heat process, said work piece having different areas with a lower thermal mass and a higher thermal mass creating a difference of temperatures across the work piece during the heat process, said support platform comprising:
a body having a plurality of areas, at least one said area having a higher thermal mass and at least one said area having a lower thermal mass;
wherein the plurality of areas of the body are positioned in the proximity of the work piece areas according to localized thermal masses on the work piece in order to reduce the difference in temperatures across the work piece.

22. A support platform of claim 21, wherein the work piece is a circuit board.

23. A support platform of claim 22, wherein the heat process is a preheat station in a wave soldering process.

24. A support platform of claim 22, wherein the heat process is a reflow oven in a reflow soldering process.

25. A support platform of claim 21, wherein the total weight of the work piece and support platform is within a set range.

26. A support platform of claim 25, wherein the set range is 4.5 to 5.5 pounds.

27. A method of improved soldering of a circuit board populated with components having differing thermal mass or thermal sensitivity, comprising:
providing a pallet to mate with said circuit board during an oven soldering operation; and
configuring the pallet such that it has areas of different thermal mass associated with different component locations on a mated circuit board.

28. A method of claim 27 wherein said pallet has areas of relatively greater or lesser thermal mass depending upon the thermal mass or thermal sensitivity of the associated circuit board component.

29. A method of claim 28 wherein said pallet areas of relatively lesser thermal mass take the form of reductions in the amount of pallet material.

30. A method of claim 28 wherein said pallet areas of relatively greater thermal mass take the form of material added to the pallet.

31. A method of improved soldering of a circuit board populated with components having differing thermal mass, comprising:
preparing a two-dimensional thermal profile of the board to identify a first board area which heats at a greater rate than a second board area;
providing a pallet to mate with and support said circuit board during an oven soldering operation;
configuring the thermal mass of the pallet such that in a first pallet area corresponding in location to said first circuit board area the thermal mass of the pallet is greater than in a second pallet area corresponding in location to said second circuit board area.

32. A method of improved soldering of a circuit board populated with components adapted to be soldered on the board passing through an oven operating in a predetermined range of temperatures, the method comprising:
providing a pallet to mate with the circuit board during an oven soldering operation; and
configuring the pallet such that it has areas of different thermal mass which are associated in location with different component locations on a mated circuit board and the magnitude of whose individual thermal masses are adapted such that said component locations have temperatures in the oven which fall within said predetermined range.

33. A method of improved soldering of a circuit board populated with components adapted to be soldered on the board passing through an oven, the method comprising:
providing a pallet to mate with the circuit board during an oven soldering operation; and
configuring the pallet such that it has areas of different thermal mass which are associated in location with different component locations on a mated circuit board and the magnitude of whose individual thermal masses are adapted to compress the temperature range of such component locations in the oven.

34. A method of improved wave, reflow, or other soldering of a circuit board populated with components adapted to be soldered on the board while passing through an oven whose temperature is within the operating temperature range of solder flux used in the soldering method, comprising:
providing a pallet to mate with the circuit board during an oven soldering operation; and
configuring the pallet such that it has areas of different thermal mass which are associated in location with different component locations on a mated circuit board and the magnitude of whose individual thermal masses are adapted such that said component locations have temperatures in the oven which fall within said flux temperature operating range.

35. A method of improving the throughput of a circuit board soldering operation wherein circuit board assemblies of varying thermal mass are intermixed on the soldering line, comprising mating with at least selected ones of the circuit board assemblies having a lower thermal mass than others a pallet whose thermal mass is chosen to augment the thermal mass of the mated circuit board assemblies and compress the range of thermal masses of the circuit board assemblies soldered.

36. For use in a method of improved soldering of a circuit board populated with components having differing thermal mass or thermal sensitivity, a pallet configured to mate with the circuit board during an oven soldering operation and having areas of different thermal mass associated with different component locations on a mated circuit board.

37. For use in a method of improved soldering of a circuit board populated with components adapted to be soldered on the board passing through an oven operating in a predetermined range of temperatures, a pallet configured to mate with the circuit board during an oven soldering operation and having areas of different thermal mass which are associated in location with different component locations on a mated circuit board and the magnitude of whose individual thermal masses are adapted such that said component locations have temperatures in the oven which fall within said predetermined range.

38. A method of improved wave, reflow, or other soldering of a circuit board populated with components adapted to be soldered on the board while passing through an oven whose temperature is within the operating temperature range of solder flux used in the soldering method, a pallet configured to mate with the circuit board during an oven soldering operation and having areas of different thermal mass which are associated in location with different component locations on a mated circuit board and the magnitude of whose individual thermal masses are adapted such that said component locations have temperatures in the oven which fall within said flux temperature operating range.
